(19) United States
(12) Patent Application Publication
(10) Pub. No.: US 2017/0066687 A1
(43) Pub. Date: Mar. 9, 2017

(54) PROCESS OF RECYCLING PAINT WASTE

(71) Applicants: James W. Price, Ventura, CA (US); David M. Long, Fullerton, CA (US)

(72) Inventors: James W. Price, Ventura, CA (US); David M. Long, Fullerton, CA (US)

(21) Appl. No.: 15/256,085

(22) Filed: Sep. 2, 2016

Related U.S. Application Data
(60) Provisional application No. 62/214,746, filed on Sep. 4, 2015.

(51) Int. Cl. C04B 18/30; C04B 7/02

(52) U.S. Cl. CPC C04B 18/30; C04B 7/02

(57) ABSTRACT

A cement composition and a process are provided for recycling a waste material by using the waste in the manufacture of Portland cement. The process generally comprises mixing a first quantity of the waste material thoroughly with a second quantity of a solid material so as to produce a non-compacted additive. The non-compacted additive is applied to cement clinker, wherein the additive is utilized as a substitute for virgin ingredients normally used in the manufacture of the Portland cement. In an embodiment, the non-compacted additive comprises a consistency of wet earth which is readily pliable with the second quantity by weight not exceeding three times the first quantity by weight. The cement clinker is then pulverized so as to distribute the additive within the resulting Portland cement.

### PRIORITY

This application claims the benefit of and priority to U.S. Provisional Application, entitled “Process of Recycling Paint Waste,” filed on Sep. 4, 2015 and having application Ser. No. 62/214,746.

### FIELD

The field of this invention relates to recycling of certain waste and more particularly to recycling of latex paints and other similar materials to be utilized as an ingredient in Portland cement which is then to be used to produce concrete building materials.

### BACKGROUND

The process of this invention is to be discussed specifically in conjunction with a latex paint. However, it is considered to be within the scope of this invention that the process could be utilized with other products such as water-based paint, water-soluble pigments, resists and water-soluble adhesives.

Latex paint is in exceedingly common usage not only by the general public but also by businesses. In recent years there has been a direction of movement from solvent based paint to the latex type of paint. The main objection to a solvent based paint is to its emission within the air of a petroleum based substance which when breathed is believed to be damaging to humans and is also potentially explosive. The result has been a substantial increase in the volume of usage of latex paints which similarly increased the waste of latex paint.

Whenever a decision is made to paint a given structure, invariably there will be provided an amount in excess of that which is actually needed. This excess becomes waste. This waste usually ends up being thrown away. The disposing of latex paint within landfills is being objected to which has resulted in increasingly restrictive state, local and federal regulations. These regulations are requiring that latex paint waste is to be handled as a hazardous waste. Disposal of a hazardous waste is an extremely expensive procedure.

Concrete building materials are manufactured in a substantial amount throughout the world. The manufacturing of a cement building material consists of a combination of an inert substance such as sand, a binder and water. The binder is typically called Portland cement. The cement reacts chemically with water to set and harden through chemical reactions,

Portland cement is a type of hydraulic cement in the form of a finely divided, gray powder composed of lime, alumina, silica and iron oxide. Small amounts of magnesium, sodium, potassium and sulfur are also present. The cement may be modified to include a plasticizer to improve adhesion, strength, flexibility and curing properties.

Cement can be manufactured by either a wet process or in a dry process. Where the raw materials have a high moisture content (such as chalk and clay), the wet process is used. The dry process is used for harder raw materials such as limestone and shale. In both processes the resulting mixture is burned generally within a kiln. The burning process can be either by calcining, roasting or autoclaving with calcining being commonly used. The operating temperature of the heat is generally about 2600 degrees Fahrenheit. During the heating process the mixture is partially fused forming lumps referred to as cement clinker. The cement clinker is then ground to the fine dry powder which is known as Portland cement. During grinding of the cement clinker, the cement may be modified to include a plasticizer or to include other specialty type of ingredients.

There are a number of mineral-based solid materials that are chemically compatible for use as an ingredient in the manufacture of Portland cement and other concrete products. These mineral-based solid materials are not typically utilized due to not being readily available to the manufacturer of the cement. Examples of such materials that are not utilized but would work satisfactorily are listed under the Detailed Description of the Preferred Embodiment.

The present invention differs from the prior art in that the product of this invention is added during the final grinding with the clinker and is not processed through the calcination portion of the manufacturing process, is not claimed to be used in the formulation or manufacture of cement clinker, and is not claimed to have fuel value. The prior art references of Pennell U.S. Pat. No. 4,081,285; Rigby et. al. U.S. Pat. No. 523,645; Babcock-Hitachi JP 357027954; Zaporozhe Titanium and Magnesium Complex, Krivoi Rog Cement Works DE A 2839829 and Cement Ind. Res. Inst. collectively address use as feed into the kiln for combining with other raw materials in clinker formation or fuel for the calcining process. The important distinction between the present invention and these citations is in the chemical transformations that occur when the raw feed materials are introduced to temperatures of calcination (about 2600° F. for a period of up to three hours).

The present invention differs from other citations such as Chapple U.S. Pat. No. 4,116,705, Sherwood et. al. U.S. Pat. No. 4,383,928, Wichner et. al. U.S. Pat. No. 5,167,711, Brunbeck et. al. U.S. Pat. No. 4,454,048, Koumal U.S. Pat. No. 5,286,427, and Hitachi Shipbld Engg KK JP A 0019472 in that the latex paint is claimed to be used in the manufacture of Portland cement rather than used in concrete or concrete products which uses Portland cement to form a monolithic structure. The cementaceous reactions that occur when Portland cement is hydrated involves chemical reactions that form a solid monolithic matrix and is the basis for all concrete technology. The present invention is that the latex paint is in a product that when ground with the clinker and gypsum enhances the performance of the resultant concrete and it is not claimed as a treatment process or a method for solidifying, immobilizing, or similar method of incorporation of the waste into a concrete matrix. None of the prior art discusses enhancement of strength or plasticity in the Portland cement when used for treatment processing or formation of the solidified mass that is used as a building material (see Sherwood U.S. Pat. No. 4,383,928). Strength enhancement and plasticity are part of the attributes of the product additive of the present invention.

The present invention is more similar to that of Kuhlmann EP 537411, Zhangabylov et. al. “Coagulation of Divinylstrene Latex in Suspensions of Portland Cement and Its Mineral Studies in Connection with Strengthening Oil Wells”, Tr. Inst. Khim. 1971, Isenburg et. al. “Hypothesis for Reinforcement of Portland Cement by Polymer Latexes”, J. Amer. Ceram. Soc. 1974, Vess U.S. Pat. No. 4,725,632, Eash U.S. Pat. No. 4,202,809, and Ceska U.S. Pat. No. 4,398,957, who claim that the use of latex additives enhance Portland cement performance. The additives consisting of finely divided latex (or chemically similar materials in a water media) solids are added to the Portland cement either at the work site or formulated with the Portland cement. The use of the latex paint additive of this invention acts in a similar fashion, replacing the virgin materials noted in these references. The novelty of the present invention is that the latex paint additive is derived from waste latex paints or chemically similar materials.

The foregoing mentioned references were cited and applied in the parent applications U.S. Ser. Nos. 08/217,276, 08/057,177 and 08/403,077.

### SUMMARY

A cement composition and a process are provided for recycling a waste material by using the waste in the manufacture of Portland cement. The process generally comprises mixing a first quantity of the waste material thoroughly with a second quantity of a solid material so as to produce a non-compacted additive. The non-compacted additive is applied to cement clinker, wherein the additive is utilized as a substitute for virgin ingredients normally used in the manufacture of the Portland cement. In an embodiment, the non-compacted additive comprises a consistency of wet earth which is readily pliable with the second quantity by weight not exceeding three times the first quantity by weight. The cement clinker is then pulverized so as to distribute the additive within the resulting Portland cement.

In an exemplary embodiment, a method for manufacturing Portland cement comprises obtaining a first quantity of a water-soluble waste; mixing the first quantity thoroughly with a second quantity of a solid material so as to produce a non-compacted additive; applying the non-compacted additive to cement clinker produced in the manufacture of the Portland cement; and pulverizing of the cement clinker so as to distribute the additive within the resulting Portland cement; wherein the water-soluble waste is recycled by utilizing the waste as the additive.

In another exemplary embodiment, the non-compacted additive is utilized as a substitute for virgin ingredients normally used in the manufacture of the Portland cement. In another exemplary embodiment, the virgin ingredients comprise at least plasticizers.

In another exemplary embodiment, the water-soluble waste is selected from the group consisting of latex paint, water base paint, water-soluble pigments, water-soluble adhesives, and water-soluble resists with waste being in liquid form or in solid form, or in a combination of liquid and solid. In another exemplary embodiment, the solid material is selected from the group consisting of calcium carbonate, combustion ash, diatomaceous earth, perlite, slag fines, aluminum dross fines, clay fines, pyrite ashes, cinder fines, shale fines, bauxite, silica sand, and dolomite. In another exemplary embodiment, the non-compacted additive comprises a consistency of wet earth which is readily pliable with the second quantity by weight not exceeding three times the first quantity by weight.

In an exemplary embodiment, a cement composition comprises pulverized cement clinker; and a non-compacted additive comprising a mixture of a first quantity of a waste material and a second quantity of a solid material; wherein the non-compacted additive is applied before the cement clinker is pulverized, such that the additive is distributed within the cement.

In another exemplary embodiment, the waste material is selected from the group consisting of latex paint, water base paint, water-soluble pigments, water-soluble adhesives, and water-soluble resists with waste being in liquid form or in solid form, or in a combination of liquid and solid. In another exemplary embodiment, the waste material comprises a resist suitable for silk screen work, etching, and chemical milling. In another exemplary embodiment, the resist is suitable for semiconductor fabrication. In another exemplary embodiment, the resist comprises a mixture of a polymer and a photoacid generator that are formulated for lithography purposes. In another exemplary embodiment, the solid material is selected from the group consisting of calcium carbonate, combustion ash, diatomaceous earth, perlite, slag fines, aluminum dross fines, clay fines, pyrite ashes, cinder fines, shale fines, bauxite, silica sand, and dolomite.

### DETAILED DESCRIPTION

In the following description, numerous specific details are set forth in order to provide a thorough understanding of the present invention. It will be apparent, however, to one of ordinary skill in the art that the present invention may be practiced without these specific details. In other instances, specific numeric references such as “first composition,” may be made. However, the specific numeric reference should not be interpreted as a literal sequential order but rather interpreted that the “first composition” is different than a “second composition.” Thus, the specific details set forth are merely exemplary. The specific details may be varied from and still be contemplated to be within the spirit and scope of the present invention. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

The process of the present invention utilizes conventional manufacturing techniques for Portland cement, either the wet process or the dry process, with each process producing, after being heated, a cement clinker. The process of the present invention utilizes a quantity of waste, such as latex paint, and combines that quantity of waste with the manufactured cement clinker. Normally this combination occurs at the time the cement clinker is pulverized into the finely divided gray powder producing Portland cement. However, the combination could occur after the cement clinker has been pulverized. The amount of waste that is added to the cement clinker or the pulverized cement varies between 0.2 percent to three percent by weight. One-half percent is the normal amount utilized with Type 1 or Type 2 cements. Three percent is the amount that is utilized with mortar or plastic cements. The product is composed of an evenly mixed one to one (by weight) relationship of latex paint and a calcium based solid material. An conglomeration having a consistency of clods to sand is produced. It is this conglomeration that is utilized in the one-half to three percent range with the Portland cement. Instead a calcium based solid material, silica material (perlite, diatomaceous earth and clay), iron based material (clay or pyrite ashes) and aluminum materials (clay or aluminum dross) could be used. A purpose of the solid mineral component is to provide color uniformity to the product of this invention.

The primary objective of the present invention is a process which utilizes a substance which is deemed by regulations to be hazardous waste in a common manufacturing operation that produces commonly available building materials, thereby eliminating the need to dispose of material that is discarded in landfills.

Another objective of the present invention is that the titanium dioxide, other pigments and fillers in the latex and water-soluble paints and coatings contribute to the total calcium and mineral requirements that are necessary in the final manufacturing of Portland cement.

Another objective of the present invention is that the processed latex waste enhances the performance and strength of concretes produced with the Portland cement.

In general, the present invention describes a process for recycling a waste material by using the waste in the manufacture of Portland cement. In an embodiment, the waste material comprises a resist suitable for semiconductor fabrication. In some embodiments, the resist may comprise a mixture of a polymer and a photoacid generator that are formulated for lithography purposes. The process generally comprises mixing a first quantity of the waste material thoroughly with a second quantity of a solid material so as to produce a non-compacted additive. The non-compacted additive is applied to cement clinker, wherein the additive is utilized as a substitute for virgin ingredients normally used in the manufacture of the Portland cement. In an embodiment, the non-compacted additive comprises a consistency of wet earth which is readily pliable with the second quantity by weight not exceeding three times the first quantity by weight. The cement clinker is then pulverized so as to distribute the additive within the resulting Portland cement.

A quantity of waste is obtained. The waste could be essentially all liquid, essentially all solid or a combination liquid and solid. A typical waste used within the process of this invention would be within the group comprising latex paint waste, water based paints, water-soluble pigments, water based coatings, resists, water-soluble glue and adhesives. Resists are liquid products used in silk screen work, etching and chemical millings. In the area of semiconductor fabrication, a resist is a thin layer deposited upon a semiconductor substrate and then used to transfer a circuit pattern thereto. A resist may be patterned via lithography to form a (sub)micrometer-scale, temporary mask that protects selected areas of the underlying substrate during subsequent processing steps. The material used to prepare the thin layer is typically a viscous solution, generally comprising proprietary mixtures of a polymer or its precursor and other small molecules (e.g. photoacid generators) that have been specifically formulated for a given lithography technology.

In some embodiments, one part of waste is to be combined by weight with one part of a mineral-based solid material, producing an additive. However, if the waste is primarily liquid, as much as three times by weight of the solid material may be used for one part by weight of the waste. The mineral-based solid material can comprise any one of the following or can comprise combinations thereof: Calcium carbonate from the manufacture of sugar from sugar beets, combustion ash from incineration processes, fly ash from emission control devices, spent filter media which comprises diatomaceous earth or perlite, calcium based material from water treatment, slag fines, aluminum dross fines, clay fines from classification systems, pyrite ashes, cinder fines from aggregate manufacture and shale fines from classification systems. Lime kiln dust, kiln dust from the firing of clay products and cement kiln dust could also be utilized. There are also usable a number of virgin materials such as ground limestone, diatomaceous earth, perlite, bauxite, clays, silica sand and dolomite. Latex paint and coatings contain significant concentrations of calcium carbonate, clay, pigments and other mineral products.

This mixing is to be accomplished thoroughly with a typical mixing apparatus such as a pug mill. A pug mill can be generally defined as a tank type container within which is mounted an auger. The auger is to be rotated which is to achieve the desired mixing of the solid material and the waste that has been deposited within the tank.

The thoroughly mixed additive is to then be removed from the mixer with such removal generally being by means of a conveyor. The consistency of the material at this time is that of a nonconsolidating wet earth. Wet earth means formed of damp granules which are pliable and can be readily manually formed into clods. It is not hard, like rock. It is conveyable but it is non-pumpable. This wet earth type of substance may then be air dried at ambient temperatures. However, drying is optional. After drying has occurred, the additive has achieved a consistency similar to dry earth with part of it being in clod-like form and other parts of it being in small granules resembling sand. This additive is combined with cement clinker which is then pulverized into the fine powder forming the Portland cement.

It is important to note that the additive is used only after the calcination forms the cement clinker. This calcining occurs only by heat treatment. However, the additive could be dried, pulverized and then evenly mixed with the fine powder Portland cement. The amount of the additive (by weight) to the Portland cement will generally be within the range of one-half percent to three percent. The additive functions as part of the materials that are required for the final manufacture of the Portland cement. Therefore, a lesser amount of these other ingredients is required when using the additive produced by the process of the present invention. A hydraulic Portland cement is composed of four main constituents which are tricalcium silicate, tricalcium aluminate, dicalcium silicate, and tetracalicum aluminoferrate. Normally included within Portland cement is also small amounts of magnesia, sodium, potassium and sulfur.

Within the prior art the ingredients of Portland cement have always been for the purpose of their mineral constituents and/or fuel value. The ingredients in the additive included within the process of the present invention are to be added to the Portland cement following the heat treatment of the Portland cement. The heat treatment, if applied to the additive included within the process of the present invention, would reduce the product value of the additive to that of the mineral components while negating the inherent value of the latex-like compounds to the finished Portland cement. Therefore, it is important to add the additive after the calcining process of the raw materials of the cement clinker. In both the wet process and dry process of cement manufacture, calcining is required to fuse the cement raw material mixture into lumps of cement clinker. The cement clinker is conducted into a kiln at the operating temperature of 2600 degrees Fahrenheit for up to three hours.

Materials in the kiln lose their identity as new chemical combinations are created, gases are exhausted, and any organic compounds burned. These combinations of occurrences are not to occur using the latex paint additive of this invention due to being added after heat treatment of the Portland cement and consequently is believed to be a novel claim of this invention. The cement clinker is then cooled to normal ambient temperature and then ground along with modifiers, such as gypsum and plasticizers, into fine powder that is known as Portland cement. It is recognized that there are known over fifty different types of Portland cement each with differing amounts and types of modifiers added. At each stage in the cement manufacture the composition is carefully monitored to ensure that the final product has the desired properties.

It is important to understand that utilizing the additive within the process of the present invention substitutes for the plasticizers that are commonly used to produce Portland cement. Also, utilizing the additive within the process of the present invention permits certain other basic ingredients to be decreased in amount. For example, since the additive includes calcium, a slightly lesser amount of a main calcium ingredient within the Portland cement only needs to be used.

The produced material from the process of the present invention can be readily transported to any manufacturing site by common vehicle such as trucks and railroad cars.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present invention is to be understood as not limited by the specific embodiments described herein, but only by scope of the appended claims.

What is claimed is:

1. A method for manufacturing Portland cement, comprising:
obtaining a first quantity of a water-soluble waste;
mixing the first quantity thoroughly with a second quantity of a solid material so as to produce a non-compacted additive;
applying the non-compacted additive to cement clinker produced in the manufacture of the Portland cement; and
pulverizing of the cement clinker so as to distribute the additive within the resulting Portland cement;
wherein the water-soluble waste is recycled by utilizing the waste as the additive.

2. The method of claim 1, wherein the non-compacted additive is utilized as a substitute for virgin ingredients normally used in the manufacture of the Portland cement.

3. The method of claim 2, wherein the virgin ingredients comprise at least plasticizers.

4. The method of claim 1, wherein the water-soluble waste is selected from the group consisting of latex paint, water base paint, water-soluble pigments, water-soluble adhesives, and water-soluble resists with waste being in liquid form or in solid form, or in a combination of liquid and solid.

5. The method of claim 1, wherein the solid material is selected from the group consisting of calcium carbonate, combustion ash, diatomaceous earth, perlite, slag fines, aluminum dross fines, clay fines, pyrite ashes, cinder fines, shale fines, bauxite, silica sand, and dolomite.

6. The method of claim 1, wherein the non-compacted additive comprises a consistency of wet earth which is readily pliable with the second quantity by weight not exceeding three times the first quantity by weight.

7. A cement composition, comprising:
pulverized cement clinker; and
a non-compacted additive comprising a mixture of a first quantity of a waste material and a second quantity of a solid material;
wherein the non-compacted additive is applied before the cement clinker is pulverized, such that the additive is distributed within the cement.

8. The cement composition of claim 7, wherein the waste material is selected from the group consisting of latex paint, water base paint, water-soluble pigments, water-soluble adhesives, and water-soluble resists with waste being in liquid form or in solid form, or in a combination of liquid and solid.

9. The cement composition of claim 7, wherein the waste material comprises a resist suitable for silk screen work, etching, and chemical milling.

10. The cement composition of claim 9, wherein the resist is suitable for semiconductor fabrication.

11. The cement composition of claim 10, wherein the resist comprises a mixture of a polymer and a photoacid generator that are formulated for lithography purposes.

12. The cement composition of claim 7, wherein the solid material is selected from the group consisting of calcium carbonate, combustion ash, diatomaceous earth, perlite, slag fines, aluminum dross fines, clay fines, pyrite ashes, cinder fines, shale fines, bauxite, silica sand, and dolomite.
